(19) United States
(12) Patent Application Publication
(10) Pub. No.: US 2022/0371965 A1
(43) Pub. Date: Nov. 24, 2022

(54) GREEN COMPOSITIONS FOR MAKING REFRACTORY CERAMIC

(71) Applicant: Omnova Solutions Inc., Beachwood, OH (US)

(72) Inventors: Carla B. McBAIN, Beachwood, OH (US); Carl SORRELL, Beachwood, OH (US); James ROBBINS, Beachwood, OH (US)

(21) Appl. No.: 17/762,066

(22) PCT Filed: Sep. 21, 2020
(86) PCT No.: PCT/US2020/051752

§ 371 Date: Mar. 20, 2022

Related U.S. Application Data
(60) Provisional application No. 62/903,019, filed on Sep. 20, 2019.

(51) Int. Cl. C04B 35/634; C04B 35/626; C04B 35/64

(52) U.S. Cl. CPC C04B 35/63408; C04B 35/6264; C04B 35/63432; C04B 35/63428; C04B 35/64; C04B 2235/602

(57) ABSTRACT

A green ceramic composition comprising (i) ceramic particles, (ii) a synthetic polymeric binder, the synthetic polymeric binder having (a) monomeric units deriving from a soft monomer, (b) monomeric units deriving from a hard non-acidic monomer, (c) monomeric units deriving from an acidic monomer, and (d) monomeric units deriving from a hydroxy-functionalized monomer, and (iii) water.

This application claims the benefit of U.S. Provisional Application Ser. No. 62/903,019 filed on Sep. 20, 2019, which is incorporated herein by reference.

### FIELD OF THE INVENTION

Embodiments of the invention are directed toward green ceramic compositions, which may be particularly useful for making fired refractory ceramic. In one or more embodiments, the green ceramic compositions include a styrene-butadiene based latex binder.

### BACKGROUND OF THE INVENTION

Ceramic materials are commonly prepared by heat treating green ceramic compositions, which typically include inorganic oxides, such as magnesia, alumina, silica, titania, and zirconia oxide. The inorganic oxides may be provided in a slurry along with additives, such as dispersants and binders. The slurry may be spray dried to produce ceramic particles. The particles may be pressed into an aggregate structure, called a green ceramic, having a desired shape and subsequently subjected to a severe heat treatment known as sintering. The sintering process converts the green ceramic into a cohesive fired ceramic, having a nearly monolithic polycrystalline ceramic phase.

The binder serves to hold the ceramic particles of the green ceramic in the desired shape after pressing. The binder can also provide lubrication while the particles are pressed. Typically, binders combust or vaporize completely during the sintering process leaving no trace of the binders in the fired ceramic. The binders nonetheless significantly affect the properties of the fired ceramics that are ultimately produced.

Synthetic polymer binders are known. For example, U.S. Pat. No. 5,358,911 discloses a binder that includes a substantially hydrolyzed copolymer of a vinyl ester and an N-vinyl amide. U.S. Pat. No. 3,472,803 discloses aqueous styrene butadiene copolymer latex emulsions can be used as a ceramic binder. Specifically disclosed in U.S. '803 are emulsions sold under the trade names XR-3100 and XR-3113, and these emulsions were provided in an amount in the range of from 4% to 12% by weight of the final composition.

U.S. Pat. No. 4,968,460 discloses ceramic binders such as esters including acrylates, SBR type polymers, ethylene vinyl acetates, NBR's, conjugated diolefins and copolymers or homopolymers of vinyl chloride and vinylidene chloride copolymers of ethylene and vinylidene chloride, copolymers of ethylene and vinyl chloride and homopolymers of vinyl aromatics polymers. The binders are emulsions generally having a polymeric content from about 45 to 60 percent, and the polymers have a T_{g} from −100 to about +120° C.

There remains a need for improved binders that provide further advantages for green ceramic compositions and fired ceramic materials.

### SUMMARY OF THE INVENTION

One or more embodiments of the present invention provide a green ceramic composition comprising i) ceramic particles, ii) a synthetic polymeric binder, the synthetic polymeric binder having (a) monomeric units deriving from a soft monomer, (b) monomeric units deriving from a hard non-acidic monomer, (c) monomeric units deriving from an acidic monomer, and (d) monomeric units deriving from a hydroxy-functionalized monomer, and iii) water.

Yet other embodiments of the present invention provide a method of making a ceramic product comprising steps of i) admixing ceramic particles with an aqueous emulsion to thereby form a green ceramic composition, the aqueous emulsion including water and polymer particles having (a) monomeric units deriving from at least one soft monomer, (b) monomeric units deriving from at least one hard non-acidic monomer, (c) monomeric units deriving from at least one acidic monomer, and (d) monomeric units deriving from at least one hydroxy-functionalized monomer, ii) forming the green ceramic composition into a green ceramic body, and iii) sintering the green ceramic body.

### BRIEF DESCRIPTION OF THE DRAWINGS

FIG. 1 is a graph showing Crush Fines and Green MOR for Inventive Examples and Comparative Examples.

FIG. 2 is a graph showing Crush Fines and Green MOR for Inventive Examples and Comparative Examples.

FIG. 3 is a graph showing extruded bars water absorption results for Inventive Examples and Comparative Examples.

FIG. 4 is a graph showing extruded bars dry and fired shrinkage results for Inventive Examples and Comparative Examples.

FIG. 5 is a graph showing pressed bars fired Modulus of Rupture (MOR) results for Inventive Examples and Comparative Examples.

### DETAILED DESCRIPTION OF ILLUSTRATIVE EMBODIMENTS

Embodiments of the present invention are based, at least in part, on the discovery of improved green ceramic compositions. The green ceramic compositions may be particularly useful for making fired refractory ceramic. The green ceramic compositions include a synthetic polymeric binder. The polymeric binder may provide an advantageous balance of properties, such as lubrication, binding, plasticizing, dispersion, compressibility, green strength, fired strength, and sufficient burn-off, to the green ceramic compositions and fired refractory ceramic made from the green ceramic compositions. According to embodiments of the invention, the polymeric binder is provided from a latex that includes polymer particles with monomeric units deriving from at least one soft monomer, monomeric units deriving from at least one hard non-acidic monomer, monomeric units deriving from at least one acidic monomer, and monomeric units deriving from at least one hydroxy-functionalized monomer. In one or more embodiments, the polymeric binder may include a styrene-butadiene based latex binder. While the prior art teaches certain synthetic polymer binders for green ceramic compositions, the polymeric binders disclosed herein offer one or more advantages over known synthetic polymer binders.

### Green Ceramic Composition

Green ceramic compositions of the present invention include a refractory base component, a synthetic polymeric binder, optionally water, and optionally other constituents conventionally included in green ceramic compositions.

### Polymeric Binder

As suggested above, the synthetic polymeric binder is provided from a latex, and therefore the polymeric binder may be referred to as a latex binder or an emulsion binder. The skilled person understands that a latex is an aqueous emulsion wherein polymeric particles are dispersed in water (i.e. a heterogeneous blend of polymer particles and water). In one or more embodiments, a blend of two or more compositionally distinct polymer particles may exist in the emulsion.

In one or more embodiments, the polymer particles of the latex are characterized by having a T_{g} from about −50° C. to about 60° C., in other embodiments from about −45° C. to about 85° C., in other embodiments from about −10° C. to about 40° C., in other embodiments, from about −15° C. to about 25° C., and in other embodiments, from about 18° C. to about 20° C. In one or more embodiments, the polymer particles are characterized by having a T_{g} of about 20° C. The T_{g} may be determined based upon dried samples or films of the latex using DSC techniques.

In one or more embodiments, the polymer particles of the latex are characterized by having a gel content of from about 55 to about 100%, in other embodiments, from about 70 to about 95%, in other embodiments, from about 75 to about 90%, in other embodiments, from about 60 to about 90%, based upon the entire weight of the particles. Gel may be determined based on insoluble fractions within a solvent such as THF or toluene.

In one or more embodiments, the polymer particles of the latex are characterized by having a mean average particle size of from about 50 to about 350 nm, in other embodiments, from about 70 to about 300 nm, in other embodiments, from about 125 to about 250 nm, in other embodiments, from about 160 to about 220 nm. In one or more embodiments, the polymer particles are characterized by having a mean average particle size of about 165 nm, in other embodiments, about 220 nm, in other embodiments, about 180 nm. Mean average particle size may be determined based on generally known testing.

In one or more embodiments, the latex is characterized by having a pH of from about 5.5 to about 11.0, in other embodiments, from about 6.0 to about 9.5, in other embodiments, from about 7.5 to about 10, and in other embodiments, from about 8 to about 9. In one or more embodiments, the latex binder can be neutralized by the addition of one or more bases, such as potassium hydroxide, sodium bicarbonate, ammonium hydroxide, sodium hydroxide, organic amines (e.g. trimethylamine), and 2-amino-2-methyl-1-propanol (sold under trade name AMP-95™). The pH may be determined based on tests known generally to those skilled in the art.

In one or more embodiments, the latex is characterized by having a viscosity of from about 25 to about 3000 cps, in other embodiments, from about 50 to about 1500 cps, in other embodiments, from about 15 to about 500 cps, and in other embodiments, from about 15 to about 3000 cps. In one or more embodiments, the latex binder is characterized by having a viscosity of less than 1000 cps, in other embodiments, less than 500 cps, in other embodiments, less than 300 cps. Viscosity may be determined based on using a Brookfield viscometer at 25° C.

In one or more embodiments, the latex is characterized by having a solids content of from about 30 to about 65, in other embodiments from about 40 to about 60, and in other embodiments from about 44 to about 56. Solids content may be determined based on using a microwave CEM or an oven that dries a latex binder sample that is weighed gravimetrically until a constant weight is obtained.

In one or more embodiments, the latex from which the polymeric binder derives include polymer particles with monomeric units deriving from at least one soft monomer, monomeric units deriving from at least one hard non-acidic monomer, monomeric units deriving from at least one acidic monomer, and monomeric units deriving from at least one hydroxy-functionalized monomer. In one or more embodiments, the aqueous emulsion includes one or more surfactants.

Soft monomers include those that upon polymerization (i.e., homopolymerization) give rise to elastomeric polymers or polymers having a T_{g} below about 0° C., preferably below about −35° C., and more preferably below about −55° C. Suitable soft monomers include conjugated dienes, butyl acrylates, 2-ethyl hexylacrylate, hydroxyethylacrylate, dimethacrylates, polyethylene glycol diacrylates, alkyl acrylates, vinyl versatate derived monomers, and mixtures thereof. Exemplary conjugated dienes include 1,3-butadiene, isoprene, 1,3-pentadiene, 1,3-hexadiene, 2, 3-dimethyl-1, 3-butadiene, 2-ethyl-1,3-butadiene, 2-methyl-1,3-pentadiene, 3-methyl-1,3-pentadiene, 4-methyl-1,3-pentadiene, and 2,4-hexadiene.

The hard non-acidic monomers include those monomers that do not include a carboxylic acid functionality and that upon polymerization (i.e., homopolymerization) give rise to thermoplastic polymers or those polymers having a T_{g} in excess of about 0° C., preferably in excess of about 75° C., and more preferably in excess of about 90° C. Suitable hard non-acidic monomers include vinyl aromatic monomers such as styrene, a-methyl styrene, t-butyl styrene, alkyl substituted styrene, divinyl benzene, and polyunsaturated divinyl compounds. Other suitable hard non-acidic monomers include acrylates such as methyl methacrylate, butyl methacrylate, vinyl acetate, and mixtures thereof. Still other suitable hard non-acidic monomers include acrylamides such as methyl acrylamide, 2-acrylamido-2-methylpropane sulfonic acid, and the salts of this acid (e.g., sodium, potassium, or ammonium salts).

Acidic monomers include those monomers that include both a carboxylic acid group as well as a polymerizable group. Acidic monomers can include both hard and soft monomers. Suitable acidic monomers include α,β-unsaturated carboxylic acids and vinyl versatic acids. Exemplary α,β-unsaturated carboxylic acids include itaconic acid, methacrylic acid, citraconic acid, cinnamic acid, acrylic acid, fumaric acid, maleic acid, and acids derived from anhydrides, such as maleic anhydride.

Hydroxy-functionalized monomers include those monomers having a hydroxy functional group, where the hydroxy functional group is not associated (i.e. not sterically interacting) with an additional acid group. Certain hydroxy-functionalized monomers may also include those monomers where the hydroxy functional group does not share a carbon atom with a carbonyl group. Certain hydroxy-functionalized monomers may also include those monomers that do not include an additional acid group.

In one or more embodiments, hydroxy-functionalized monomers may be defined by the formula

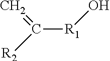

where R₁ is an ester linkage or a hydrocarbylene group, and where R₂ is hydrogen or a methyl group. In particular embodiments, R₁ is an ester linkage or an aromatic group. In one or more embodiments, R₁ may be generically characterized as a compound that allows the 1-diene double bond to react to the backbone of the polymer. Exemplary alkyl groups of the alkoxy group in the ester linkage include an ethyl group and a propyl group. Exemplary aromatic groups for R₁ include a benzyl group and a phenyl group.

In particular embodiments, R₁ is an ester linkage having ethyl in the alkoxy group, and R₂ is hydrogen, such that the hydroxy-functionalized monomer is hydroxyethyl acrylate.

In one or more embodiments R₁ is an ester linkage having ethyl in the alkoxy group, and R₂ is a methyl group, such that the hydroxy-functionalized monomer is hydroxyethyl methacrylate.

In one or more embodiments, R₁ is a phenyl group, and R₂ is hydrogen, such that the hydroxy-functionalized monomer is hydroxystyrene. The hydroxystyrene may be 4-hydroxystyrene or 3-hydroxystyrene.

In one or more embodiments, the hydroxy-functionalized monomer is made from an epoxy in a two-step reaction, as generally known to a person skilled in the art.

As generally known in the art, the relative amounts of the various monomers employed to synthesize the polymer particles may be tailored in order to achieve the desired characteristics set forth herein. Also, the conversion time, polymerization temperature, and type and level of chain transfer agent may also be manipulated, particularly for controlling the degree of gel.

In one embodiment, the polymer particles can include from about 5 to about 75 wt. %, in other embodiments, from about 15 to about 60 wt. %, in other embodiments from about 15 to about 45 wt. %, and in other embodiments from about 20 to about 45 wt. %, units deriving from soft monomer, based upon the entire weight of the polymer particles.

In one embodiment, the polymer particles can include from about 25 to about 95 wt. %, in other embodiments from about 40 to about 85wt. %, in other embodiments from about 45 to about 85 wt. %, and in other embodiments from about 55 to about 80 wt. %, units deriving from hard non-acidic monomer, based upon the entire weight of the polymer particles.

In one or more embodiments, the polymer particles can include from about 0.05 to about 12 wt. %, in other embodiments from about 0.1 to about 12 wt. %, in other embodiments from about 0.1 to about 5 wt. %, and in other embodiments from about 0.1 to about 2 wt. %, units bearing an acid functionality (i.e., a carboxylic acid group), based upon the entire weight of the polymer particles. In one or more embodiments, the polymer particles can include less than 10 wt. %, in other embodiments less than 8 wt. %, and in other embodiments less than 5 wt. %, units bearing an acid functionality (i.e., a carboxylic acid group), based upon the entire weight of the polymer particles.

Acid content can be determined based upon the weight of the acid bearing monomers employed in synthesizing the polymer or by FTIR techniques.

In one embodiment, the polymer particles can include from about 0.1 to about 10 wt. %, in other embodiments from about 0.1 to about 8 wt. %, in other embodiments from about 0.5 to about 6 wt. %, and in other embodiments from about 1.0 to about 4 wt. %, units deriving from soft monomer, based upon the entire weight of the polymer particles.

In a particular embodiment, the latex binder includes polymer particles with monomeric units deriving from 1,3-butadiene, monomeric units deriving from styrene, monomeric units deriving from itaconic acid, monomeric units deriving from methacrylic acid, monomeric units deriving from hydroxyethyl acrylate, and monomeric units deriving from an alkyl mercaptan.

### Method of Making Latex Binder

In one or more embodiments, the latex compositions that provide the latex binder can be prepared by employing conventional emulsion polymerization techniques. Emulsion polymerization is described in U.S. Pat. Nos. 5,166,259 and 6,425,978, which are incorporated herein by reference.

In one or more embodiments, an emulsion polymerization technique may utilize a single-charge batch polymerization process, in other embodiments, a continuous system may be used, which may employ a CSTR, in other embodiments, a semi-batch or continuous-feed process may be used, and in other embodiments, an incremental process may be employed. In one or more embodiments, the polymer particles are prepared by employing an incremental polymerization technique. In one or more embodiments, this includes the use of a polymer seed such as one prepared by the polymerization of itaconic acid and styrene in the presence of a suitable surfactant.

Once the seeds are prepared, incremental additions of soft monomer, hard non-acidic monomer, acidic monomer, hydroxy-functionalized monomer, initiator, chain transfer agent, and surfactant are introduced. A similar technique is set forth in U.S. Pat. No. 6,425,978, which is incorporated herein by reference.

In one or more embodiments, polymerization of the polymeric particles may be carried out at a temperature of from about 45° C. to about 90° C., and in other embodiments from about 55° C. to about 75° C.

In general, useful polymerization processes employ the use of a free-radical initiators to initiate the polymerization of monomer in the presence of a surfactant. In one or more embodiments, free-radical initiators may be employed.

In one or more embodiments, exemplary useful free-radical initiators include ammonium persulfate, sodium persulfate, potassium persulfate, tert-butyl hydroperoxide, and di-tert-butyl cumene. Multiple free-radical initiators may be used. In one or more embodiments, the initiators may be used in conjunction with one or more reducing agents such as iron salts, amines, ascorbic acids, sodium salts of ascorbates, and sodium formaldehyde sulfoxylates. Any suitable amounts of initiator and reducing agent can be utilized.

In one or more embodiments, useful surfactants include alkali metal salts of an alkyl sulfosuccinate. Suitable alkali salts of alkyl sulfosuccinates include sodium dihexyl sulfosuccinate, sodium dioctyl sulfosuccinate, sodium octane sulfonate, alkyl phenol ethoxylates, fatty alcohol ethoxylates, alkyl polyglucosides, alkyl phosphates. Suitable surfactants include those available under the tradenames Aerosol™ MA-80 (Cytec), Gemtex™ 80 (Finetex), and MM-80™ (Uniqema).

In one or more embodiments, useful surfactants include salts of alkyl sulfates and salts of organo disulfonates. Suitable salts of alkyl sulfates include sodium lauryl sulfate, available under the trade names Stepanol WA and Texapon™ (Cognis), Polystep™ B-3 (Stepan), Polystep™ B-5 (Stepan), or Rhodapon™ UB (Rhodia). Suitable salts of organo disulfonates include sodium dodecyl diphenyloxide disulfonate, which is available under the tradename Dowfax 2A1 as well as Stepanol™ AM, Polystep™ B-7 (Stepan), Rhodapon™ L-22EP (Rhodia), Dowfax™ 2A1 (Dow), Calfax™ DB-45 (Pilot), Rhodacal™ DSS (Rhodia), and Aerosol™ DPOS-45 (Cytec).

Other suitable surfactants include sodium laureth sulfate, Laureth-3 (a.k.a. triethylene glycol dodecyl ether), Laureth-4 (a.k.a. PEG-4 lauryl ether), Laureth-5 (a.k.a. PEG-5 lauryl ether), Laureth-6 (a.k.a. PEG-6 lauryl ether), Laureth-7 (a.k.a. PEG-7 lauryl ether), sodium lauryl ether sulfate, sodium laureth-12 sulfate (a.k.a PEG (12) lauryl ether sulfate, and sodium laureth-30 sulfate (a.k.a. PEG (30) lauryl ether sulfate). Other ether alkyl sulfates are available under the tradenames Polystep™ B40(Stepan) and Genapol™ TSM.

In addition to those surfactants described above, other surfactants that may be used with an emulsion polymerization (in addition to or in lieu of those described) include alkyl sulfates, alkyl sulfosuccinates, alkyl aryl sulfonates, a-olefin sulfonates, fatty or rosin acids salts, NPE, alkyl aryl sulfonates, alkyl phenol ethoxylates, and fatty acid alcohol ethoxylates. In one or more embodiments, the surfactant includes a blend of sodium dihexyl sulfosuccinate and sodium dioctyl sulfosuccinate. The blend can be adjusted to control or obtain a desired critical micelle concentration.

In one or more embodiments, the aqueous emulsion can include from about 0.1 to about 10 wt. %, in other embodiments, from about 1 to about 6 wt. %, and in other embodiments, from about 2 to about 4 wt. %, surfactant, based upon the total weight of the aqueous emulsion. Stated another way, in one or more embodiments, the surfactant is present in an amount from about 0.2 to about 1.0, in other embodiments, from about 0.25 to about 0.65, in other embodiments, from about 0.35 to about 0.55, in other embodiments, from about 0.40 to about 0.50, and in other embodiments, from about 0.44 to about 0.48 parts by weight surfactant per 100 parts by weight polymer, where the parts by weight surfactant refer to active surfactant content.

Depending on the polymerization technique employed, and more specifically on the type and quantity of surfactant employed, the latex resulting from the polymerization discussed above can be employed as the latex binder composition for a green ceramic composition. Alternatively, surfactant can be post added after polymerization to form the latex binder composition. In one or more embodiments, the surfactant may be the same surfactant as described herein as being in the latex binder.

In one or more embodiments, a chain transfer agent is employed in the polymerization. Any chain transfer agents conventionally employed in the emulsion polymerization of conjugated diene monomers may be employed. Exemplary chain transfer agents include, alkyl mercaptans (e.g. sold under the trade name Sulfole™), carbon tetrachloride, carbon tetrabromide, C₂-C₂₂ n-alkyl alcohols, C₂-C₂₂ branched alcohols, and 2,4-diphenyl-4-methyl-1-pentene.

In one or more embodiments, the polymer particles include from about 0 to about 2.5 wt. %, in other embodiments, from about 0 to about 1.5 wt. %, and in other embodiments, from about 0.2 to about 1.0 wt. % chain transfer agent, based upon the entire weight of the polymer particles.

In one or more embodiments, especially where the latex binder is foamed, the latex binder may include one or more surfactants particularly characterized as froth agents. Suitable froth agents include disodium stearyl sulfosuccinamate, available under the trade names Aerosol™ 18, Aerosol™ A18P (Cytec), Monawet™ SNO (Uniqema), Octosol™ 18 (Tiarco), and Stanfax™ 318, 319, 377 (Para-Chem). These surfactants characterized as froth agents may be employed in conjunction with one or more of the surfactants described above or together with thickeners such as sodium carboxymethylcellulose.

### Refractory Base Component

As suggested above, the green ceramic compositions of the present invention include a refractory base component. In one or more embodiments, the green ceramic compositions include two or more refractory base components.

Suitable refractory base components, which may also be referred to as ceramic particles, ceramic materials, or ceramic base components, include, without limitation, magnesium oxide (magnesia), aluminum oxide (alumina), silicon oxide (silica), titanium oxide, zirconium oxide, iron oxide, calcium oxide, calcium hydroxide, clay, brick material, or mixtures of two or more thereof. The one or more refractory base components may also be provided with water independent of the water provided with one or more latex binders. In one or more embodiments, one or more of the refractory base components are provided as hydrous compounds, for example, hydrous silicates of aluminum (Al₂O₃·2SiO₂·2H₂O).

As generally known to the skilled person, clay is a finely-grained natural rock or soil material that includes one or more clay minerals with optional traces of quartz (SiO₂), metal oxides (for example, Al₂O₃, MgO) and organic matter. As generally known to the skilled person, clay minerals are hydrous aluminum phyllosilicates, optionally with amounts of iron, magnesium, alkali metals, alkaline earths, and other cations.

In one or more embodiments, ceramic particles are characterized by having a mean average particle size of from about 2 to about 45 microns, in other embodiments, from about 20 to about 150 microns, in other embodiments, from about 45 to about 2,000 microns, in other embodiments, from about 2 to about 2,000 microns.

In one or more embodiments, the refractory base components may include a brick composition. Brick material may include, for example, clay, clay-bearing soil, sand, concrete, and mixtures thereof.

In one or more embodiments, the one or more refractory base components may include a low-clay, high-alumina composition. In one or more embodiments, a low-clay, high-alumina composition may include from about 0% to 30% clay, and from about 100% to 85% alumina, based on the total weight of the refractory base components.

In one or more embodiments, the one or more refractory base components may include as a high-clay, low-alumina composition. In one or more embodiments, a high-clay, low-alumina composition may include from about 70% to 100% clay, and from about 28% to 45% alumina, based on the total weight of the refractory base components.

In one or more embodiments, the one or more refractory base components may include a non-clay, basic-brick composition. In one or more embodiments, a non-clay, basic-brick composition may include from about 0% to 5% clay, and from about 95% to 100% of metallic oxides such as Magnesium Oxide, Chromium Oxide, Calcium Oxide, Dolomite, either singly or in combination, or metallic silicates, such as zirconium silicate, based on the total weight of the refractory base components.

In one or more embodiments, the one or more refractory base components may include a fire clay composition. As generally known to the skilled person, fire clay may generally be described as mineral aggregate composed of hydrous silicates of aluminum (Al₂O₃·2SiO₂·2H₂O) with or without free silica. In one or more embodiments, a fire clay composition may include from about 20% to 40% Al₂O₃, and from about 45% to 65% SiO₂, based on the total weight of the refractory base components.

In one or more embodiments, the one or more refractory base components may be characterized as an extrudable composition. In one or more embodiments, the one or more refractory base components may be characterized as an extrudable alumina-based composition. In one or more embodiments, an extrudable alumina-based composition may include from about 0% to 25% clay, metallic oxides, metallic silicates, either singly or in combination and from about 75% to 100% alumina, based on the total weight of the green ceramic composition.

In one or more embodiments, the one or more refractory base components may include a high alumina powder composition. In one or more embodiments, a high alumina powder composition may include from about 0% to 25% clay, metallic oxides, metallic silicates, either singly or in combination and from about 75% to 100% alumina, based on the total weight of the green ceramic composition.

### Other Components of Green Ceramic Composition

In addition to the refractory base component, the synthetic polymeric binder, and optional water, the green ceramic compositions of the present invention may include other constituents that may be conventionally used in green ceramic compositions.

In one or more embodiments, the green ceramic compositions also include one or more additional binders. Suitable additional binders include polyvinvyl alcohol, modified corn starch, and dextrin.

In one or more embodiments, the green ceramic compositions also include one or more additional plasticizers. A suitable additional plasticizer is methyl cellulose.

In one or more embodiments, the green ceramic compositions also include one or more additional lubricants. A suitable additional lubricant includes sodium sterate.

In one or more embodiments, the latex binder provides suitable lubrication, binding, and plasticizing properties to the green ceramic compositions such that the green ceramic compositions may be devoid of, or substantially devoid of, additional binders, additional plasticizers, and additional lubricants.

### Green Ceramic Compositional Amounts

The skilled person understands that the solids portion of a synthetic latex primary includes polymeric particles and residual amounts of other solids within the latex such as surfactants. Reference may therefore be made to latex solids, which includes the solids portion of the latex including the synthetic polymeric binder.

In one or more embodiments, the green ceramic compositions of the present invention may include from about 0.1 to about 1 wt. %, in other embodiments from about 0.5 to about 5 wt. %, in other embodiments from about 0.07 to about 3 wt. %, and in other embodiments from about 0.1 wt. % to about 5 wt. % latex solids, based on the total weight of the latex solids and the one or more refractory base components. For purposes of this specification, the latex solids and the refractory base components may be referred to as a dry green ceramic composition.

### Method For Forming Green Ceramic Composition And Green Ceramic Bodies

In one or more embodiments, the green ceramic compositions may be formed by combining a refractory base component (i.e. ceramic particles) with a synthetic latex, which is described herein. In one or more embodiments, this may produce a slurry of ceramic particles and latex polymer. The mixture of ceramic particles and latex may undergo admixing to distribute the latex polymer and/or ceramic particles throughout the composition. Water may be added and admixed, as well as the other optional constituents.

In one or more embodiments, the composition formed by combining the ceramic particles and latex (e.g. a slurry) can dried to form green ceramic particles, which may include ceramic particles in contact with or coated or partially coating with synthetic latex polymer from the latex. In one or more embodiments, these green ceramic particles may be formed by spray drying of the slurry or other water-laden composition.

In one or more embodiments, the green ceramic compositions, with or without drying, may be formed into a green ceramic body having a desired shape. For example, the green ceramic composition in the form of a slurry may be subjected to shape forming and dewatering at the same time (such as in a mold) to form the green ceramic body. In other embodiments, the green ceramic particles (e.g. those obtained by spray drying) can be pressed in to a desired shape to form a green ceramic body. In one or more embodiments, the green ceramic composition may be in the form a an extrudable composition, which may be extruded to form the green ceramic body. In one or more embodiments, the green ceramic composition or green ceramic particles may be provided in an injectable composition, which may be injection molded to form the green ceramic body.

The green ceramic body may be subsequently subjected to a severe heat treatment known as sintering. The sintering process allows the latex binder of the green ceramic body to combust or vaporize, which converts the green ceramic body into a cohesive fired ceramic product. The fired ceramic product may have a monolithic, or nearly monolithic, polycrystalline ceramic phase.

Suitable forms for the fired ceramic product include refractory bricks, refractory board, ceramic thin wall catalyst support members (e.g., automobile catalytic converters structures), ceramic proppant particles, catalyst support, and tile.

### Properties Of Green Ceramic Composition

As disclosed herein, the latex binders of the present invention are particularly useful for binding green ceramic compositions. The green ceramic compositions may be characterized by the properties thereof.

In one or more embodiments, green ceramic compositions may be characterized by Green Modulus of Rupture (MOR). Green MOR may be determined by ASTM C674, which is a 3 point bending test. In one or more embodiments, green

MOR may be at least 0.4 pounds-force (lb_{f}), in other embodiments, at least 0.45 lb_{f}, and in other embodiments, at least 0.5 lb_{f}.

### Fired Ceramic Properties

In one or more embodiments, fired ceramic products may be characterized by fired water absorption. Fired water absorption may be determined by placing fired samples in boiling water for 2 hours followed by a 24 soak. Lower absorption of water indicates a tighter body with less opportunity for penetration by hot metals or erosive gases when the fired ceramic product is utilized in service.

In one or more embodiments, fired ceramic products may be characterized by fired Modulus of Rupture (MOR). Fired MOR may be determined by ASTM C674, which is a 3 point bending test.

### Other—Monolithic Refractories

In one or more embodiments, a latex binder described herein may be used as a flow aid for a separate dry binder. Many conventional binders are shipped dry and subsequently water activated. This is particularly the case in the manufacture of monolithic refractories, such as for castables, gunning mixes, and patching mixes. In one or more embodiments, a latex binder described herein may be used to water activate a dry binder.

### INDUSTRIAL APPLICABILITY

In one or more embodiments, the present invention possesses industrial applicability as providing green ceramic compositions that may be particularly useful for making fired refractory ceramic.

### EXAMPLES

### Example 1

Comparative Example 1 and Comparative Example 2 samples were prepared using latex generally known as carboxylated, non-hydroxy functionalized latex. Inventive Example 1 samples were prepared utilizing latex in accord with the above description of the invention, and therefore may be referred to as utilizing carboxylated, hydroxy functionalized latex. Details are shown in Table 1.

All ceramic samples were prepared as generally known to the skilled person for Crush Fines % testing and Green Strength testing. Green Strength was performed in accord with ASTM C674. Each of the samples was tested at different wt. % of the latex binder with respect to the latex binder and the one or more refractory base components (i.e. the dry green ceramic composition). The testing was done by granulation testing in Light Weight Proppant (LWP) on dry basis of the binders.

TABLE 1

| | Comparative | Comparative | Inventive |
|---|---|---|---|
| | Example 1 | Example 2 | Example 1 |
| Type of Latex | Carboxylated, | Carboxylated, | Carboxylated, |
| | non-hydroxy | non-hydroxy | hydroxy |
| | functionalized | functionalized | functionalized |
| Total Solids (%) | 47-50 | 47-49 | 44-56 |
| pH | 6.0-7.5 | 6.0-8.0 | 8.0-9.0 |
| Viscosity (cP) | 75-400 | <400 | <300 |
| Glass Transition | −5 | 10 | 18-20 |
| Temperature (Tg) (° C.) | | | |
| Relative Particle Size | Average | Ultra-Small | 160-20 nm |

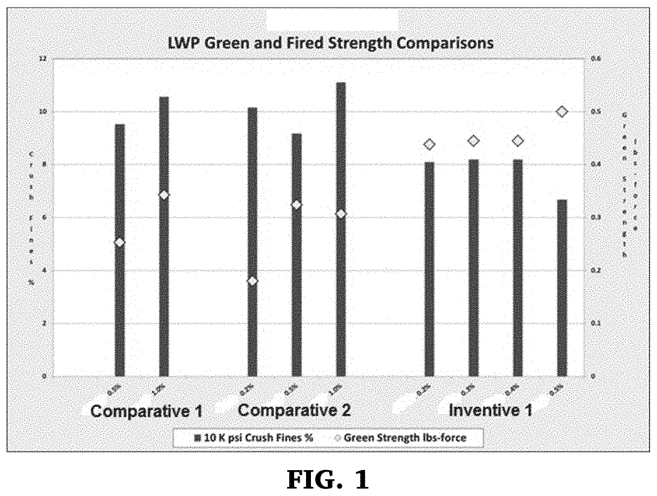

As seen in the below Table 2, and as further shown in FIG. 1, Inventive Example 1 had lower Crush Fines % and higher Green Strength than Comparative Example 1 and Comparative Example 2.

TABLE 2

| | Comparative | | Comparative | | | | | | |
|---|---|---|---|---|---|---|---|---|---|
| | Example 1 | | Example 2 | | | Inventive Example 1 | | | |
| Weight Binder (%) | 0.5 | 1.0 | 0.2 | 0.5 | 1.0 | 0.2 | 0.3 | 0.5 | 1.0 |
| 10K psi Crush | 9.53 | 10.57 | 10.16 | 9.18 | 11.11 | 8.09 | 8.18 | 8.02 | 6.67 |
| Fines (%) | | | | | | | | | |
| Green Strength | 0.253 | 0.342 | 0.18 | 0.324 | 0.307 | 0.438 | 0.445 | 0.479 | 0.50 |
| (lbs-force) | | | | | | | | | |

### Example 2

Comparative Examples samples included certain materials generally utilized commercially as ceramic binder, and other comparative materials. Comparative Examples included water only, 0.5 wt. % PVA, 1.0 wt % PVA, 1 wt % modified corn starch, 2 wt. % modified corn starch, 4 wt % modified corn starch, 0.5 wt. % dextrin.

Inventive Example 1 samples were prepared utilizing latex in accord with the above description of the invention. Inventive Example samples were prepared at 0.2 wt. % latex, 0.3 wt % latex, 0.5 wt. % latex, and 1.0 wt. % latex, with respect to the latex binder and the one or more refractory base components (i.e. the dry green ceramic composition).

All samples were prepared as generally known to the skilled person for the respective testing.

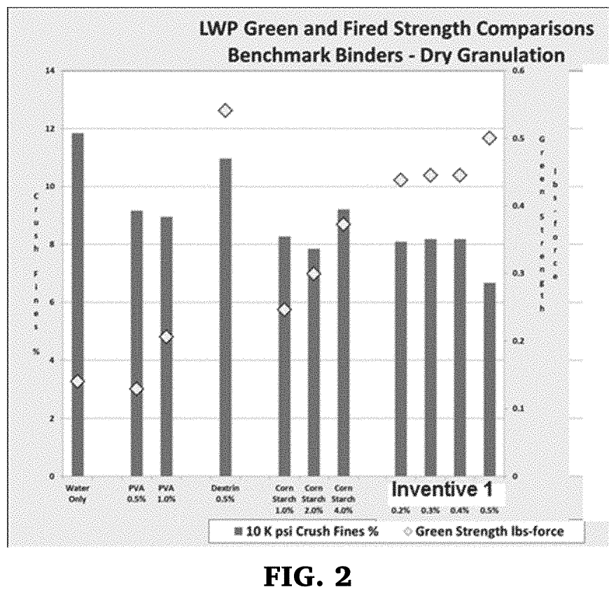

Crush Fines % and Green Strength results are shown in the below Table 3, and further shown in FIG. 2. Green Strength was performed in accord with ASTM

| | Water | | | | | | | | | | |
|---|---|---|---|---|---|---|---|---|---|---|---|
| | Only | PVA | | Dextrin | Corn Starch | | | Inventive Example 1 | | | |
| Weight Binder (%) | 0 | 0.5 | 1.0 | 0.5 | 1.0 | 2.0 | 4.0 | 0.2 | 0.3 | 0.5 | 1.0 |
| 10K psi Crush | 11.84 | 9.16 | 8.95 | 10.97 | 8.26 | 7.84 | 9.20 | 8.09 | 8.18 | 8.02 | 6.67 |
| Fines (%) | | | | | | | | | | | |
| Green Strength | 0.14 | 0.129 | 0.21 | 0.541 | 0.246 | 0.299 | 0.372 | 0.438 | 0.445 | 0.479 | 0.50 |
| (lbs-force) | | | | | | | | | | | |

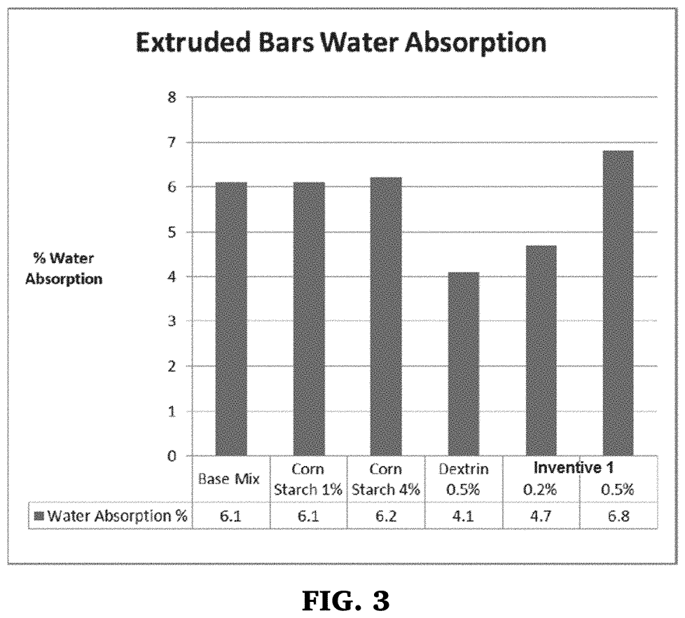

Extruded bars water absorption results are shown below in Table 4 and in FIG. 3. Low water absorption was tested by placing fired samples in boiling water for 2 hours followed by a 24 soak is a standard test used to determine the porosity of a sample. Lower absorption of water indicates a tighter body with less opportunity for penetration by hot metals or erosive gases in service.

TABLE 4

| | Water | | | | Inventive | |
|---|---|---|---|---|---|---|
| | Only | Dextrin | Corn Starch | | Example 1 | |
| Weight Binder (%) | 0 | 0.5 | 1.0 | 4.0 | 0.2 | 0.5 |
| Water Absorption (%) | 6.1 | 4.1 | 6.1 | 6.2 | 4.7 | 6.8 |

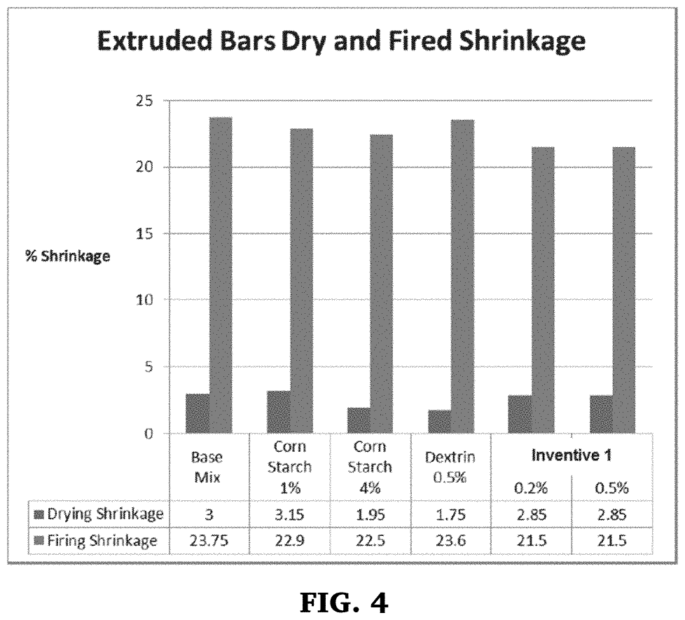

Extruded bars dry and fired shrinkage results are shown below in Table 5 and in FIG. 4. Raw to dry firing shrinkage is important in determining the packing of the extruded particle. Lower values indicate less open space for shrinkage during drying. A tighter dry body will also result in lower fired shrinkage. In both cases, lower shrinkage will result in fewer defects during processing.

TABLE 5

| | Water | | | | Inventive | |
|---|---|---|---|---|---|---|
| | Only | Dextrin | Corn Starch | | Example 1 | |
| Weight Binder (%) | 0 | 0.5 | 1.0 | 4.0 | 0.2 | 0.5 |
| Drying | 3 | 1.75 | 3.15 | 1.95 | 2.85 | 2.85 |
| Shrinkage (%) | | | | | | |
| Firing | 23.75 | 23.6 | 22.9 | 22.5 | 21.5 | 21.5 |
| Shrinkage (%) | | | | | | |

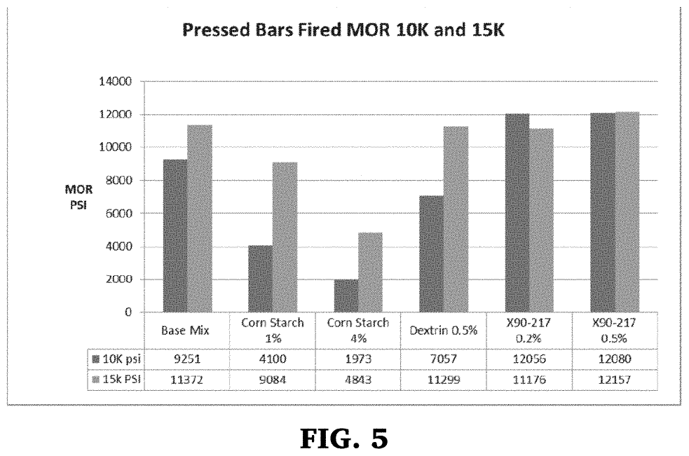

Pressed bars fired Modulus of Rupture (MOR) results are shown below in Table 6 and in FIG. 5. Pressing pressures used were 10,000 psi and 15,000 psi.

TABLE 6

| | Water | | | | Inventive | |
|---|---|---|---|---|---|---|
| | Only | Dextrin | Corn Starch | | Example 1 | |
| Weight Binder (%) | 0 | 0.5 | 1.0 | 4.0 | 0.2 | 0.5 |
| Fired MOR 10K (psi) | 9251 | 7057 | 4100 | 1973 | 12056 | 12080 |
| Fired MOR 15K (psi) | 11372 | 11299 | 9084 | 4843 | 11176 | 12157 |

Various modifications and alterations that do not depart from the scope and spirit of this invention will become apparent to those skilled in the art. This invention is not to be duly limited to the illustrative embodiments set forth herein.

1. A green ceramic composition comprising:
i. ceramic particles,
ii. a synthetic polymeric binder, the synthetic polymeric binder having
(a) monomeric units deriving from a soft monomer,
(b) monomeric units deriving from a hard non-acidic monomer,
(c) monomeric units deriving from an acidic monomer, and
(d) monomeric units deriving from a hydroxy-functionalized monomer, and
iii. water.

2. The green ceramic composition of claim 1, wherein synthetic polymeric binder binds the ceramic particles.

3. The green ceramic composition of claim 1, wherein the soft monomer is 1,3-butadiene.

4. The green ceramic composition of claim 3, wherein the hard non-acidic monomer is styrene.

5. The green ceramic composition of claim 4, wherein the acidic monomer is itaconic acid.

6. The green ceramic composition of claim 1, wherein the hydroxy-functionalized monomer is defined by the formula 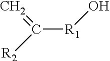
where R₁ is an ester linkage or an aromatic group, and where R₂ is hydrogen or a methyl group.

7. The green ceramic composition of claim 6, wherein the hydroxy-functionalized monomer is hydroxyethyl acrylate.

8. The green ceramic composition of claim 1, wherein the synthetic polymeric binder has a T_{g} of from −15 ° C. to 60 ° C.

9. The green ceramic composition of claim 1, wherein the monomeric units deriving from a soft monomer are present in an amount of from about 15 to about 45 wt. %, based on the total weight of the synthetic polymeric binder.

10. The green ceramic composition of claim 1, wherein the monomeric units deriving from a hard non-acidic monomer are present in an amount of from 45 to 85 wt. %, based on the total weight of the synthetic polymeric binder.

11. The green ceramic composition of claim 1, wherein the monomeric units deriving from an acidic monomer are present in an amount of from 0.1 to 12 wt. %, based on the total weight of the synthetic polymeric binder.

12. The green ceramic composition of claim 1, wherein the monomeric units deriving from a hydroxy-functionalized monomer are present in an amount of from 0.1 to 8 wt. %, based on the total weight of the synthetic polymeric binder.

13. The green ceramic composition of claim 1, wherein the synthetic polymeric binder present in an amount of from about 0.1 wt % to about 5 wt. %, based on the total weight of the synthetic polymeric binder and ceramic particles.

14. The green ceramic composition of claim 1, the synthetic polymeric binder derives from a latex having with polymeric particles having a mean average particle size of from 50 nm to 350 nm.

15. A fired ceramic product made from the green ceramic composition of claim 1.

16. A method of making a ceramic product comprising steps of:
i. admixing ceramic particles with an aqueous emulsion to thereby form a green ceramic composition, the aqueous emulsion including water and polymer particles having
(a) monomeric units deriving from at least one soft monomer,
(b) monomeric units deriving from at least one hard non-acidic monomer,
(c) monomeric units deriving from at least one acidic monomer, and
(d) monomeric units deriving from at least one hydroxy-functionalized monomer,
ii. forming the green ceramic composition into a green ceramic body, and
iii. sintering the green ceramic body.
